(19) United States
(12) Patent Application Publication
(10) Pub. No.: US 2002/0082912 A1
(43) Pub. Date: Jun. 27, 2002

(54) Transactions between vendors and customers using push/pull model

(76) Inventors: Leon Batachia, Bucharest (RO); Adrian Amariei, Medford, MA (US)

Correspondence Address: Yong S. Choi, Esq., Mintz, Levin, Cohn, Ferris, Glovsky and Popeo, P.C., One Financial Center, Boston, MA, 02111, US

(21) Appl. No.: 09/746,984

(22) Filed: Dec. 22, 2000

(51) Int. Cl. G06F 17/60

(52) U.S. Cl. 705/14; 705/26

(57) ABSTRACT

An offer and acceptance method and apparatus where the vendor generates offer package for customer acceptance. The offer packages may be created and sent towards a customer (customers) according with a particular policy.

### FIELD OF THE INVENTION

The invention relates to a channel to sell products or services and in particular, to a market platform that uses the Internet and/or wireless communication to sell products or services by offering improved matching of customer against capacity.

### BACKGROUND OF THE INVENTION

The efficient utilization of information and communication has been the key to success of many business ventures. To obtain a competitive edge many companies have resorted to technology to disseminate, process and communicate information. For example, computers and fax machines have made possible almost instantaneous correspondence between two companies in which a business agreement could be expeditiously reached. The advent of the Internet has brought about new business opportunities that are categorically referred to as electronic commerce (e-commerce). E-commerce comes in a variety of forms such as business-to-business commerce (B2B commerce), business-to-customer commerce (B2C commerce) and customer-to-customer commerce (C2C commerce). E-commerce uses various business models such as providing a service in return for an advertising space on the customer's display or an online catalog that also allows for online entry of orders.

Many e-commerce models are based on a “pull” model where a customer (or business) will “pull” contents from a Website according to their needs. In many instances, the customer will employ a “search engine” that searches the various Websites for contents that the customer is looking for. From a content provider's point of view, assuming a passive role where the customer's activities dictate whether its Website will be assessed is undesirable and is inefficient. In a “push” model, the content provider actively reaches out to its customers and “pushes” the contents on them. For example, the content provider may use a mailing list to send to their customers updated information about services, products or news. The information may be sent to all customers on the list or the information may be sent to targeted customers in accordance to their profile.

A previous problem concerning the Internet has been that instant access and mobility were substantially limited because, typically access to the Internet was performed using a computer that was tethered to a telephone line. For this and other reasons, many devices have been developed such as a laptop computer with a wireless modem, wireless Personal Digital Assistant (PDA), handheld Personal Computer (PC) with wireless capability and mobile phone with Internet access capability. Some of these devices may access the Internet using wireless access protocol (WAP).

### SUMMARY OF THE INVENTION

An offer and acceptance method and apparatus where the vendor generates offer package for customer acceptance. The offer packages may be created and sent towards a customer (customers) according with a particular policy.

### BRIEF DESCRIPTION OF THE DRAWINGS

FIG. 1 is a diagram showing an exemplary offer and acceptance based on a push model;

FIG. 2 is a diagram showing an offer package having multiple offers;

FIG. 3 is a diagram showing an exemplary offer and acceptance based on a pull model;

FIG. 4 is a diagram showing an exemplary sequence of interactions of a telephone company (telco) using a dynamic pricing strategy;

FIG. 5 is a system that establishes transactions between vendors and buyers;

FIG. 6 is a diagram that shows a network in which the system of FIG. 5 may be used; and FIG. 7 shows a push/pull model using intelligent agents.

### DETAILED DESCRIPTION

The invention relates to establishing transactions between vendors and customers by utilizing a push/pull platform based on an offer and acceptance model. The offer and acceptance model may be based on various economic and non-economic policies. To aid in the understanding of the invention a revenue management policy will be used for purposes of illustrating an example of a policy that may be used. Different concepts related to revenue (or yield) management practices, principles and strategies are described in a book titled “Yield Management: Strategies for the Service Industries”, by Ian Yeoman and Anthony Ingold, Cassel Wellington House, ISBN O-3O4-33894-X˜ disclosure of which is incorporated herein by reference.

Revenue management (or yield management) allocates products and services in a manner that maximizes profit or revenue. Stated differently, revenue management is a collection of management techniques and methods that can help a business sell the right product or service to a right customer at a right time for a right price. Examples of applicable businesses are car rentals, freight transports, airlines, hotels, cruise lines, telephony networks (wireline or wireless networks), and so forth. These businesses may share certain characteristics such as perishability, segmentability and available capacity.

Perishability is where a product or service loses value or becomes unavailable during or after a certain time event. The nature of the product or service is such that unsold capacity is lost since it cannot be inventoried. For instance, an empty seat on a flight, an empty room in a hotel or unused network capacity or bandwidth for a mobile operator can not be recovered and represents lost revenue. Segmentability refers to the ability to segment customers based on a willingness to pay using different rates, different purchase or use restrictions and other elements that may characterize an offer for products or services. Available capacity largely depends on an industry sector. For instance, certain businesses such as a car rental firm can change the size of their fleet at a moderate cost. In contrast, telephone companies (telcos), hotels and airlines have a fairly fixed capacity and increasing capacity implies a high cost. Another issue related to fairly fixed capacity is the inability to increase available capacity at a given moment in order to satisfy a peak demand. For example, a mobile operator may be overloaded at a certain location during a specific time due to peak usage. The mobile operator cannot increase the capacity instantly to satisfy the customers' demand. However, building new infrastructure to increase the capacity does not justify the cost when the peak usage is merely periodic or sporadic.

Fairly fixed capacity offers conditions in which revenue management policies may be used. Another characteristic that indicates good conditions is low variable costs. Variable costs refers to costs of putting an additional customer in otherwise unused capacity. For example, to a mobile operator, this is the cost of assuring that a call can be made; for an airline, this is the cost of additional meal and fuel; and for a hotel, this is the cost of cleaning the room and any amenities.

Capacity may be managed using price. In economic theory, price is the main factor used to explain links between supply and demand for a product or service. Thus, revenue management is a complex relationship between demand, supply and price. When demand is low discounted prices are made available. When demand is high, discounted rates are not available and an opportunity even arises to increase the price beyond a normal or published rate. By offering multiple rates in a dynamic pricing approach, businesses may maximize their profits and revenues. In offering multiple rates an issue to consider is an offer and acceptance model. In one instance, the vendor makes an offer and the customer accepts (an example of push model). In another instance, the buyer requests for an offer and the vendor presents an offer which the buyer accepts (an example of pull model). A differentiation between push and pull model is whether an offer is made available by a vendor initiative or a customer initiative respectively. From the vendor's point, it is desirable to make the offer as flexible as possible for the buyer to accept the offer. The offer decision mechanisms may be based according to policies such as the revenue management policy.

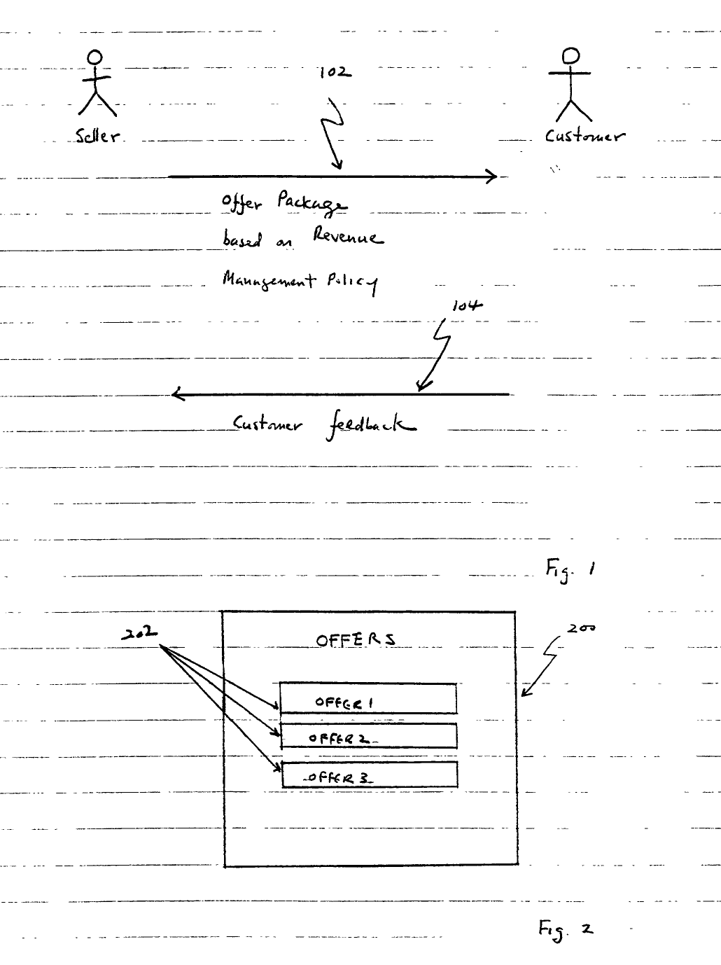

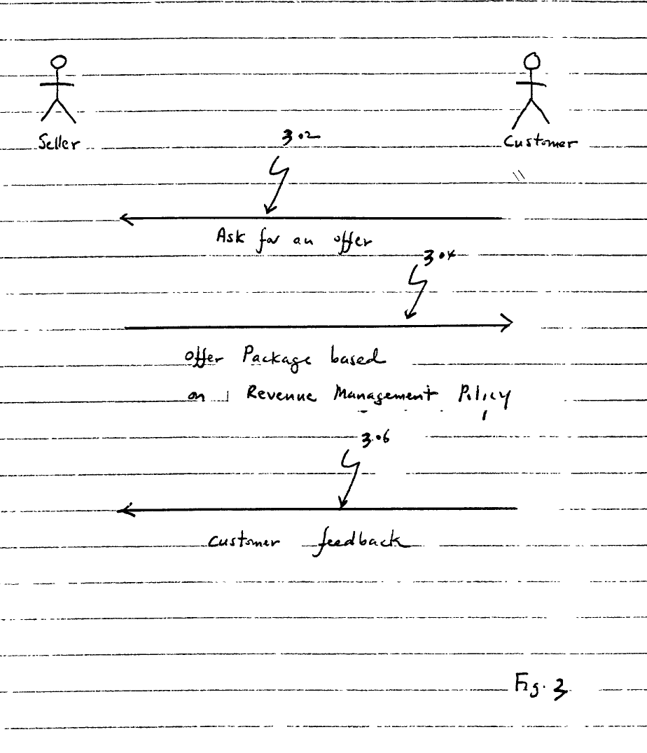

FIG. 1 is a diagram illustrating an exemplary offer and acceptance using a push model. In stage 102, the vendor makes an offer package to a customer in accordance with a policy such as a revenue management policy. The offer package may be dynamically generated using customer profile, customer preference, previously captured behavior, specific business rules and/or environmental parameters. FIG. 2 illustrates an exemplary offer package 200 having multiple offers 202, in this instance three offers, that may be sent to a customer. The vendor pushes to a specific customer the offer package at a perceived appropriate moment for proposing offers. The vendor may produce several offer packages where each package is formed for a particular target customer or customers. In stage 104, the customer may reject the offer package, ignore it or accept one or more offers from the package. In one instance, the customer will have an opportunity to respond to the offer immediately (approaching real time when the offers are received on a cellular phone, for example). In another instance, the offer package is time sensitive and expires if the customer does not respond in time. Accepting an offer in some situations means buying the offered product or service while others may indicate just booking the respective offer.

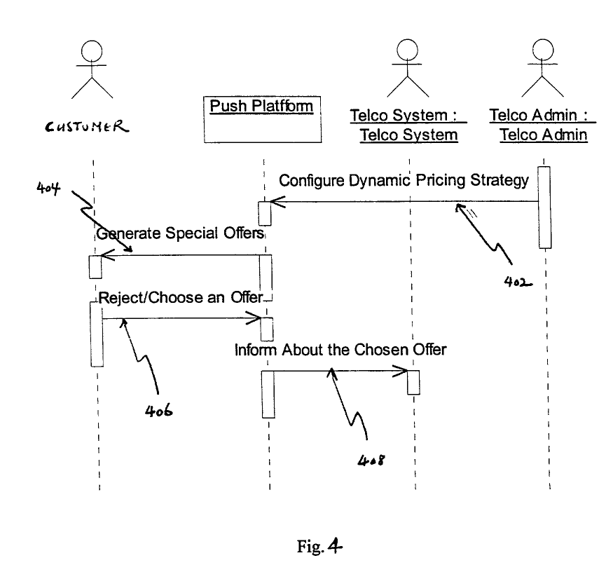

FIG. 3 is a diagram of an exemplary offer and acceptance using a pull model. In stage 302, the customer initiates the vendor to make an offer. In stage 304, the vendor responses to the customer request with an offer package according to its revenue management policy in a manner that may be similar to that described in stage 302. In stage 306 the processes that follow, including the customer feedback or behavior may be similar to stage 104.

From the described two models, market segments may be kept apart and full rates (or even higher rates, for example when demand is very high) and discounted rates may be offered concurrently (and in an environment where the vendor “meets” the customers individually). Opportunities for forming the environment are available where Internet and personal devices like mobile phones, PDAs, personal computers, e-mail accounts, etc. are omnipresent. In particular, a wireless device that may utilize the Internet may also be a terminal that delivers information and services to the customer in times of greatest need; the wireless device may be always with the customer and it may know the physical location of the customer. The content provider thus may localize information, services and advertising from the Web around the customer and, in essence, move the Web along with the customer. Vendors interested in using push/pull model to provide services may benefit from opportunities available in wireless communication. An aspect of wireless communication is the practice of dynamic pricing of products and/or services due to possibilities of getting rapid responses (approaching real-time) to their pushed offers because a wireless device usually accompanies the owner.

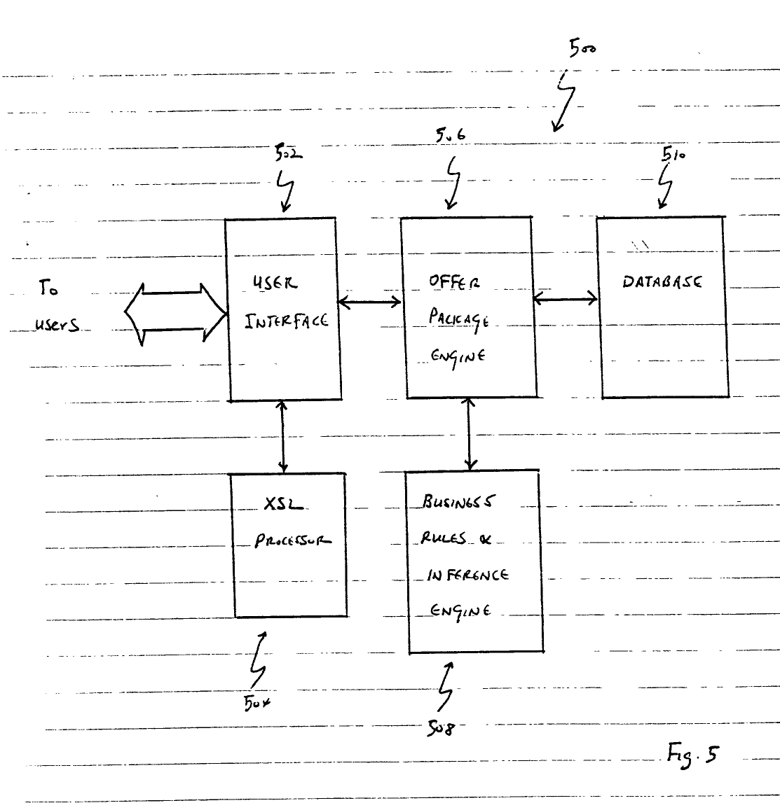

FIG. 4 is a diagram that illustrates an exemplary sequence of interactions of a telco using a dynamic pricing strategy. In stage 402, a telco administrator configures the dynamic pricing strategy of the telco that creates special offers for individual customers or a group of customers. The telco administrator may create the special offers using business rules derived from appropriate policies, user profiles such as static profiles (such as the type of contact with telco, whether the customer is private or a business) and/or dynamic profiles (such as peak hours for the customer, the percentage of previous offers accepted, minutes of use and etc.) and/or customer preferences. The configuration may be saved in a database at the push platform. In stage 404, the push platform sends customized special offers at the appropriate moment to the customers selected by consulting the business rules and/or configuration settings in the database. The push platform may also use environmental parameters when sending special offers. For example, when the telco's network is underloaded, telco may attract customers by dynamically generating special offers or when telco's network is overloaded, telco may dynamically generate special offers to customers that may need the guarantee service. In stage 406, the customer receives one or more personalized offers. For example, an offer may specify a price per minute, a time of day the offer refers to, and the duration of the offer. The customer may select one or more offers, or reject them all. In stage 408, the selection of the customer is transmitted back to telco where the selection may be processed and the customer profile may be updated.

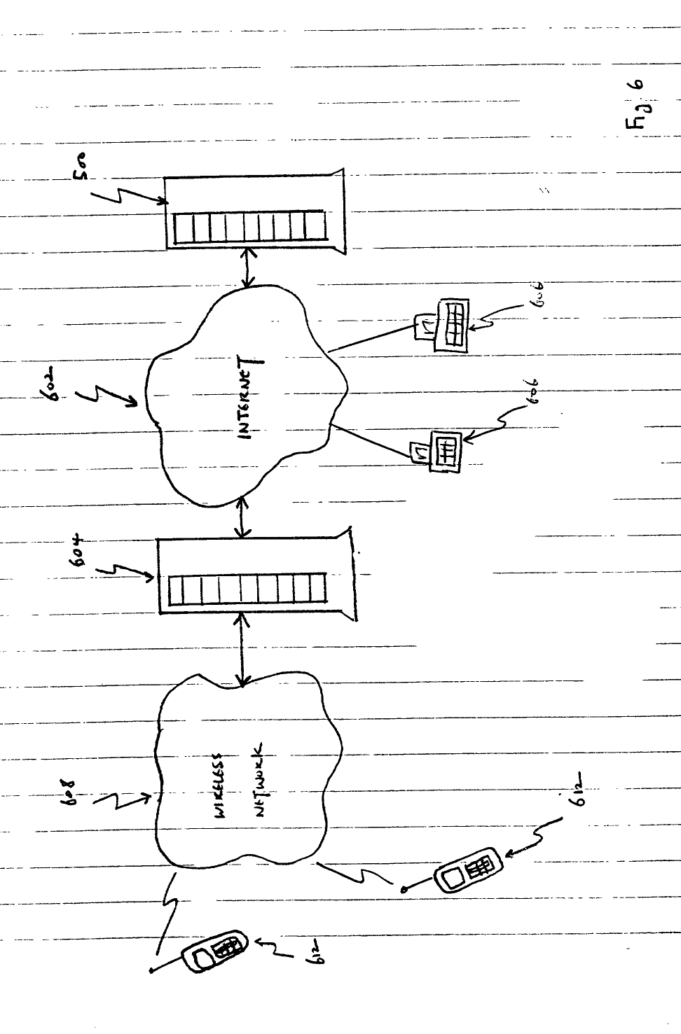

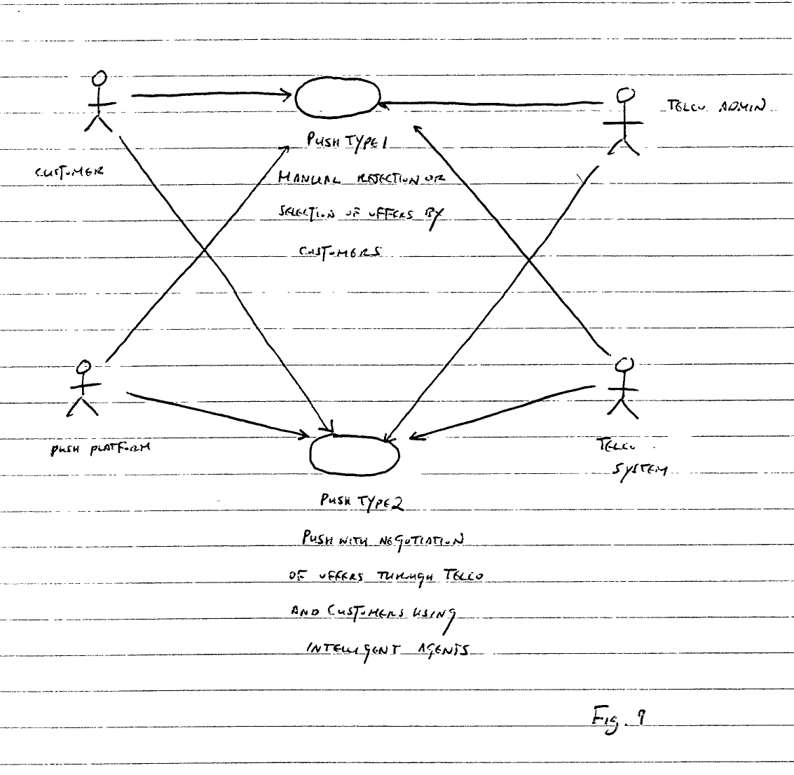

FIG. 5 shows one possible system 500 that may be used implement various push/pull platforms. The system 500 comprises a user interface 502, an extensible style language (XSL) processor 504, an offer package engine 506, a business rules and inference engine 508 and a database 510. The system 500 may be implemented in a computer server that is connected to the Internet 602 as shown in FIG. 6. Computers 606 connected to the Internet 602 communicate and exchange information with the system 500 via the Internet 602. Wireless devices 612 may also be connected to the system 500 via the wireless network 608 and the WAP gateway 604 that is in communication with the system 500 via the Internet 602. Referring to FIG. 5, the system 500 may be constructed using an object-oriented approach and may follow various principles such as flexibility, scalability, modularity, portability and distribution of processing. Interaction with customers is handled by the user interface 502 that uses an Application Program Interface of the Web server (Netscape Server Application Program Interface—NSAPI or Internet Server Application Program Interface—ISAPI, for example). Customers may connect to the user interface 502 through a hypertext markup language (“HTML”) interface (via hypertext transfer protocol (HTTP)). For customers possessing global system for mobile communication (“GSM”) phones, another interface possibility is the wireless markup language (“WML”) (via wireless access protocol (WAP)). Customers may connect to the system 500 through the Internet, via Extended Markup Language (“XML. Thus, customers that intend to use the services of the system 500 may connect to it in accordance with their desired preference. The NSAPI (ISAPI) module may maintain the temporary data' involved in HTTP or WAP sessions and generate appropriate XML files. These files contain information to be presented to the customer (i.e., XML defines a way of structuring the information, without involving presentation). To render the information in an appropriate form on the customer's device (such as a computer or a wireless device) the XML files are sent to the XSL processor 504 together with corresponding XSL files created for presentation purposes. The XSL processor 504 outputs for example HTML pages (if the customer's device is a computer) or WML pages (if the customer's device is a wireless device) that are sent back for presentation in a specific browser on the customer's device through the user interface 502.

The offer package engine (which may also be a push/pull platform) 506 generates a package containing one or more offers and/or options that target a particular customer or customers based on policies of the business rules and inference engine 508 and data in the database 510. A factor that may be considered when offers are made is customer preferences. Customer preferences may be stored in the database 510 and used to filter offers. The customer may specify in his or her preferences for example, the intervals of acceptability for different attributes characterizing an offer (price, quantity, etc.), the period(s) of time when he or she agrees to receive offers, etc. In another instance, the vendor takes creates and sends offers using predicted behavior of the customers obtained by inference or previous interactions.

Another factor to consider is that a higher price than the customer will accept reduces or eliminates sales. A low price that doesn't meet profit objectives is also undesirable. However, it may be that a price of a product or service may depend on a customer perception of value. The business rules and inference engine 508 and the database 510 help the vendor to better estimate the customer perceived value and help the customer to evaluate the offers in terms of utility (not only in terms of price per inventory unit but also taking into account other attributes of the product or service). Package sent towards a specific customer or group of customers in accordance with the revenue management policy may contain a single offer or a set of alternative offers located within the acceptable domain of the customer(s). Such a domain may be identified from voluntarily expressed customer preferences and/or previously captured or inferred behavior of the customer(s). A customer may ignore or reject the whole package or may select for acceptance from the package the alternative that expresses to him or her maximum utility. In addition to the level of price, a concrete offer made available to a customer may contain values for other attributes, which may count in the overall evaluation of the offer, like quality, speed of making available the product or service the customer will pay for. For example, in wireless communications an airtime offer for cellular phone subscribers may contain, in addition to price per minute, other elements like the time period the offer refers to (in some situations the airtime offer becomes available immediately after selection and acceptance), the total call duration allowed at the rate specified in the offer, the duration of the offer and so forth.

Depending on the level of demand, occupancy or usage level of capacity and other parameters or business rules, prices in the offers may be lower or higher than the normal rate. The pull/push platform based on offer and acceptance model provides ways to differentiate market segments for each level of the rate. For instance, the offer and acceptance model may be used to acquire a range of useful data that may be obtained by simple interactions with customers. For example, in the wireless communication industry, typical periods in which network operator may offer discounted rates are during off-peak hours. During peak times, when the network usage may be at full capacity, there are opportunities for operators to sell bandwidth or airtime at rates higher than normal rates. Certain customers may accept higher rates in exchange for guaranteed access to the network. A guaranteed access may be a commodity for a customer that needs to make calls during peak hours. When a specific offer is made available through a pull or push mechanism, the customer's reaction is recorded and stored in the database 510. Using this knowledge, the vendor makes offers to an individual customer without involving other customers (for example by using customer personal devices) and the vendor is able to segment the market and offer different rates concurrently and dynamically to various customers. Customer's perceived value may also be supplemented using methods such as identifying patterns customer behavior, forecasting demand or inferring business rules using specific software tools based on data mining techniques.

For example, in a data mining process for a telco situation, the main sources of data are usually either the generic Database component of the push platform or the data stored in the call records in the billing system of the telco. The billing record for each call includes fields such as:

originating and terminating numbers

location where the call was placed

account number of the person who originated the call

duration of the call

time and date, etc.

All these data may be explored and analyzed (through automatic or semiautomatic means) to discover customer behavior patterns that can be used in formulating marketing and customer support strategies.

Another example of data mining source is a history of no-shows. No-shows refer to the customers who have reserved (a hotel room, an airline seat, an airtime offer, etc.) but who do not arrive to take up their reservation. Usually the vendor overbook themselves to guard against the possibility of no-shows. A push/pull platform may store data, providing statistics and inferring business rules related to no-shows. The no-shows may be taken into account when offers are made to customers. Another factor to consider is that the revenue management problem may need to be solved repeatedly. Moreover, there may be a need that a solution be fast, fairly accurate and not too expensive. A lot of data that may appear when solving repeatedly a problem. The resulted data, if stored in a database 510, in time may become potential source of knowledge that may be extracted to be used for better solving similar problems in the future.

The business rules and inference engine 508 provides the offer decision mechanism when making offers to customers. Where several businesses are involved in providing products and services to customers each business may designate its own administrator to establish and maintain its set of rules. Access to a particular business account's rule set may be restricted to the authorized administrator of that business account. The main component of the business rule engine 508 may be configured as an inference engine, which, together with sets of rules and data possibly extracted from the database 510 or received as inputs from other modules external to the system 500 (such as a data service provider) forms the basis of the revenue management policy. These business rules may determine the nature and form of a package along with its offers and/or options. These may include decisions about rack rate and discounted pricing, decisions about the number of offers to be made available to customers for each level of rate, decisions related to timing of offers and related to timing of acceptance of bookings, decisions about overbooking practices and its level, which customers to book out (for example when full capacity is reached) and so forth. While the decisions may be statically determined, preferably, the decisions are driven dynamically based on events and information, for example, by forecasted demand, by events causing unexpected trends in demand, by inventory/capacity level, inventory/capacity level below or above a threshold and so forth, events which can be combined with patterns in customer behavior previously determined, overbooking statistics and so forth to form the basis of environmental parameters.

The business and inference engine 508 may be implemented using variety of methods that range from simple rule-based heuristics to very sophisticated mathematical models having hundreds decision variables. One embodiment is using an expert system. Expert systems are programs designed to model the problem-solving ability of human experts. There are two main components of an expert system: the knowledge base and the inference engine. These components model two major traits of human experts: the expert's knowledge and reasoning. The knowledge base contains highly specialized knowledge on the problem area as provided by the expert(s). It includes problem facts, rules, concepts and relationships. How this knowledge is coded into the knowledge base is the subject of knowledge representation. Typical examples of knowledge representation techniques are: object-attribute-value triplets, rules, semantic networks, frames, etc. The inference engine is the knowledge processor that is modeled after the expert's reasoning. Examples of expert systems together with various design and development approaches are described in the book of John Durkin, Expert Systems: design and development, Prentice-Hall, 1994, ISBN 0-02-330970-9, disclosure of which is incorporated herein by reference. The experience accumulated in revenue management practices can be captured in a knowledge base of an expert system together with other type of knowledge (heuristic knowledge, theoretical knowledge embodied within theories, concepts, etc.). This knowledge may be expressed as business rules database. The expert system could be designed to control and validate a part of or the whole revenue management policy.

In another embodiment, a more complex and flexible offer and acceptance mechanism may be used using intelligent agents acting on behalf of the customer and vendor. The agent, acting on a customer behalf, negotiates in terms dictated by its master and, in consequence, takes into account also the customer preferences. Thus, instead of vendor sending personalized offers and a customer just selecting an appropriate alternative offer from the received package, both parties enter in a negotiation through intelligent agents. The customers and vendors are able to properly configure their own agents in terms of goals, acceptability domains for attributes compounding an offer package (and other constraints like deadline for negotiation) and strategy followed in negotiation. Agents have autonomy in negotiation but in general any user has total control over his or her agent and may intervene in any moment to stop the agent, re-launch it or to modify its behavior in negotiation, by changing the configuration settings. Also, business rules may be properly set by vendors to control and validate their agents' behaviors. If the negotiation is finished with a deal, the terms of the deal represent the actual offer that is proposed to the customer for acceptance. There are a multitude of architectures of intelligent agents and models followed in intelligent agent negotiations of the offers. It may be for example a particular variation of the model described in the application patent entitled “Negotiation Using Intelligent Agents” filed______ and having a Ser. No.______, which is incorporated herein by reference.

FIG. 7 shows a range of embodiments involving the push/pull platform. However, note that the embodiments may be implemented within the same platform as a multifunction platform. In push type 1, the telco administrator configures the dynamic pricing strategy of the respective telco, creating special offers for individual customers or for a group of customers, and setting appropriate business rules. The telco administrator takes into account both the customer profiles: the static profile and/or the dynamic profile, as well as their preferences. The telco administrator settings are saved in the database. The push platform sends customized special offers at the appropriate time and to the customers that are selected by consulting the business rules and/or configuration setting from the database and/or other environmental parameters. The behavior of the push platform may be directed by an expert system. A customer receives on his/her phone one or more customized offers that are available for a clearly specified period of time, and may select one or more offers or reject them all.

The customers may specify their preferences regarding the type or content of the messages they are interested in. In the case of messages of type offer package, the customers may also indicate the range of acceptability of the prices of the contained offers and times of day when they prefer to receive such messages. In customer preferences, the customers may also specify the kind of messages they prefer to receive directly on their wireless devices, the kind of messages that will be accessible only on the platform via HTTP or WAP, and the kinds of messages they prefer to have forwarded to other devices like e-mail systems, faxes, pagers, etc.,. These customer preferences may be used to filter the messages before they reach different Customers' personal devices or personal accounts, to better satisfy the customers' needs and to avoid overwhelming customers with unnecessary messages.

Push type 2 represents a sophisticated implementation of push platform. Intelligent agents act on behalf of both important sides involved: the telco (represented by telco admin) and the customer. The set of tasks that may be delegated to the intelligent agents includes negotiation. The intelligent agents that act for customers negotiate with intelligent agents delegated by the telco for special offers or information content that is pushed towards their phones. During negotiations, the intelligent agents exchange messages, evaluate incoming messages in terms of scoring or utility functions specified by their owners, and take into account their profiles, preferences, business rules, the type of the message, offer content, offer prices, etc.. For example, in negotiating offers, a criterion that an intelligent agent may consider is the reservation price specified by its owner. Or, in negotiating the content of pushed information, the customer's intelligent agents may consider the information type of incoming message. Usually, the customer specifies the interesting types of information in customer preferences or profiles.

Many advantages and benefits are believed to be attained from the invention. For example, the vendor may send offers based on dynamic pricing that will negotiate customer-specified request and available capacity at any point in time and determine a price that satisfies both individual customers and the vendor. Furthermore, the offer is discreet and specific to a target customer thereby is invisible to other customers. For instance, in the wireless communication business, the invention constantly compares vendor capacity and pricing policies against user preferences to generate offers to different segment of customers that result in increased consumption of perishable airtime. Vendors can reserve capacity to be sold at premium rates during peak calling times by understanding their premium customers' individual requirements and price sensitivity. In another example, the invention will inform customers that they can conveniently book roaming airtime in advance of travel, just as they would book airplane tickets, hotel, and car rentals.

While various embodiments of the application have been described, it will be apparent to those of ordinary skill in the art that many more embodiments and implementations are possible within the scope of the invention. Accordingly, the invention is not to be restricted except in light of the attached claims and their equivalents.

what is claimed is:

1. An offer and acceptance method comprising:
generating an offer based on policy; and
pushing the offer to a customer.

2. The method as in claim 1, further comprising:
receiving a customer request for the offer.

3. The method as in claim 1, wherein generating the offer further comprises:
using an intelligent agent to generate the offer.

4. The method as in claim 1, wherein generating the offer further comprises:
generating an offer package having a plurality of options.

5. The method as in claim 4, wherein generating the plurality of options further comprises:
generating the options based on customer profile.

6. The method as in claim 4, wherein generating the plurality of options further comprises:
generating the options based on customer preferences.

7. The method as in claim 4, wherein generating the plurality of options further comprises:
generating the options based on a predicted behavior of the customer.

8. The method as in claim 4, wherein generating the plurality of options further comprises:
generating the options based on a customer's perceived value.

9. The method as in claim 4, wherein generating the plurality of options further comprises:
taking into consideration no-shows.

10. The method as in claim 1, wherein the policy is generated using a revenue management policy.

11. The method as in claim 1, wherein the policy is generated using heuristics.

12. The method as in claim 1, wherein the policy is generated using an expert system.

13. The method as in claim 1, wherein the policy is expressed in business rules.

14. The method as in claim 1, wherein generating the offer further comprises:
dynamically generating the offer.

15. The method as in claim 14, wherein dynamically generating the offer comprises:
using environmental parameters.

16. The method as in claim 4, further comprising:
generating a plurality of offer packages, each offer package directed to a target customer/customers.

17. The method as in claim 4, further comprising:
receiving a customer's selection; and
updating a customer profile based on the selection.

18. The method as in claim 1, further comprising:
negotiating the offer with a customer's intelligent agent.

19. An offer and acceptance apparatus comprising:
means for generating an offer based on policy; and
means for pushing the offer to a customer.

20. The apparatus as in claim 19, further comprising:
means for a customer to request the offer.

21. The apparatus as in claim 19, further comprising means for generating the policy coupled to the offer generating means.

22. The apparatus as in claim 19, wherein the offer generating means further comprises:
means for dynamically generating the offer.

23. The apparatus as in claim 19 further comprising means to transmit the offer to the customer.

24. The apparatus as in claim 19, further comprising:
means for the customer to negotiate the offer.

43. An offer and acceptance system comprising:
an offer package engine to generate an offer package based on policy; and
a business rules engine to supply business rules derived from the policy that is considered in generating the offer package.

44. The offer and acceptance system as in claim 43, further comprising:
the offer package having a plurality of options.

45. The offer and acceptance system as in claim 43, further comprising:
the policy is based on a revenue management policy.

46. The offer and acceptance system as in claim 43, further comprising:
the policy is based on heuristics.

47. The offer and acceptance system as in claim 43, further comprising:
the policy is based on an expert system.

48. The offer and acceptance system as in claim 43, wherein the offer package engine is configured to push the offer package.

49. The offer and acceptance system as in claim 43, wherein the offer package engine is configured to receive a request for the offer package.

50. The offer and acceptance system as in claim 43, further comprising:
a database to store a customer profile that is considered in generating the offer package.

51. The offer and acceptance system as in claim 50, further comprising:
the customer profile includes a customer's perceived value that is considered in generating the offer package.

52. The offer and acceptance system as in claim 50, further comprising:
the customer profile includes a predicted behavior of a customer that is considered in generating the offer package.

53. The offer and acceptance system as in claim 50, further comprising:
the customer profile includes a customer preference that is considered in generating the offer package.

54. The offer and acceptance system as in claim 50, further comprising:
the database to store a history of no-shows that is considered in generating the offer package.

55. The offer and acceptance system as in claim 43, further comprising:
the offer package engine configured to dynamically generate the offer package; and
the business rules engine configured to cause the offer package engine to dynamically generate the offer package based on environmental parameters.

56. The offer and acceptance system as in claim 50, further comprising:
the offer package engine configured to generate a plurality of offer packages, each offer package is directed to a target customer/customers based on the customer profile.

57. The offer and acceptance system as in claim 43, further comprising:
an user interface to interact with customers.

58. The offer and acceptance system as in claim 57, further comprising:
the user interface coupled to Internet.

59. The offer and acceptance system as in claim 57, further comprising:
the user interface coupled to a wireless network.

60. The offer and acceptance system as in claim 43, further comprising:
the offer package engine having a system intelligent agent that generates an offer package.

61. The offer and acceptance system as in claim 60, further comprising:
the system intelligent agent configured to interact with a customer intelligent agent to negotiate the offer package.
